(19) United States
(12) Patent Application Publication
(10) Pub. No.: US 2008/0059605 A1
(43) Pub. Date: Mar. 6, 2008

(54) SYSTEMS AND METHODS FOR OPERATING COMMUNICATION PROCESSES USING A PERSONALIZED COMMUNICATION WEB SERVER

(76) Inventors: Shaul Shalev, Savion (IL); Josef Berger, Santa Clara, CA (US)

Correspondence Address: SCHNECK & SCHNECK, P.O. BOX 2-E, SAN JOSE, CA, 95109-0005, US

(21) Appl. No.: 11/625,644

(22) Filed: Jan. 22, 2007

Related U.S. Application Data
(60) Provisional application No. 60/760,499, filed on Jan. 20, 2006.

(51) Int. Cl. G06F 15/16

(52) U.S. Cl. 709/217

(57) ABSTRACT

System and methods are disclosed for employing personalized switching and routing Communication Web Server (PCWS), enabling prompt activation, maintaining, monitoring and documenting of personalized communication processes, created and stored by PCWS authorized users, using PCWS guided procedure. Processes are either adopted for personalization from qualified process libraries offered by the PCWS, or customized by users utilizing the PCWS software. Thus, unskilled users can personalize complex “soft-switch” tasks for optimizing communication processes through a multitude of alternative channels, networks and devices with one or many communicating entities. The system's processes can be programmed to transfer information in forms such as audio, data, or video. Once personalized and stored in the PCWS site, remote activation of a process requires no more than an authorized initiator's submission of short, prompt Activation Message (AM) to the PCWS, wherein the AM contains the necessary identifiers of the message sender and the activated process.

### CROSS REFERENCE TO RELATED APPLICATION

This application claims priority from U.S. provisional application No. 60/760,499, which was filed on Jan. 20, 2006.

### TECHNICAL FIELD

The current invention relates to communication processes, information-flow and service enabling system and methods in general, and more specifically to a system and methods for enabling users to adapt, customize and create personalized communication processes, information flows and service requests by preprogramming, using centralized software tools, and once defined and stored in a communication server, activating the personalized processes by authorized user's submittal of a unique short activation message to be received and decoded by said server.

### BACKGROUND ART

Different systems enable communication connections and services today. The Public Switched Telephone Network (PSTN) and the mobile networks enable their users to dial from their telephones and mobile devices and create connections with other telephone and mobile devices on different networks accessible to these devices

Routing networks enable data connection between devices. Voice and data over Internet protocol (IP) networks enable lower cost and higher flexibility of voice and data communication among users.

To date, Voice Over IP (VOIP) services enable users to communicate freely between themselves and for a relatively low charge to dial phone numbers from their VOIP enabled computers and communication devices.

Currently the landline PSTNs, Mobile systems and the routing networks are programmed to deliver connections to many users in well-defined formats of communication creation.

These formats include, for example, dialing the telephone number to be connected to, or selecting the other parties' names from a preprogrammed telephone book, or creating IP number connection by click on the other user identified name on the computer display or on an IP-telephone display.

Although very easy to operate by users, such prior art communication connection systems have relatively limited functionality. The network-switching core is initiated by the users' communication devices located at the edge of the network via a very simple submission of control information. The initiation includes sending the address (e.g. phone number), of the remote device to be connected to the initiating device. The submission activates the switching and routing processes of the syste, for establishing communication connection between the initiating and remote users devices, followed by users transferring information over the established communication channel.

The PSTN, mobile and routing systems are limited to very basic communication switching and routing such as user to user connection, user to multiple users connection (conference call), call forward, where a call connection to a phone number is forwarded to another number and call waiting where a communicating entity on one connection get notified that he has a second call waiting and can switch between the calls.

Data transmissions such as e-mails, chat messages and Short Message Services (SMS) are one to one and one to many data distribution connections which are activated by initiating a manual “send” command.

The current PSTN Mobile and routing systems and their operators do not enable users to program their systems beyond the simple connections process and services offered by manufacturers. Some advanced services, designed mainly for corporations' employees allow limited set-up configuration of soft-switches by the users. Such systems allow, for example, the duplication of incoming calls to ring at two phone lines simultaneously till one line is picked up.

In general the prior art switching, routing and gateway communication and networking systems are closed systems; they are programmed by the system and network operators to deliver robust but very limited communication connectivity functionality.

There is a need to enable users to define their own communication connectivity provisioning and set up processes from remote computers over the Internet as well as activating those processes in a very simple and easy to use methodology.

There is also a need to provide a method that enables each user to provision and activate advanced combined processes of the form of: “search connections,” “find connections,” “connect the found connections” and “inform process”.

In accordance with the former needs, there is also a need to enable the advanced process by an initiation procedure incorporating a very short and simple and therefore intuitive Activation Message (AM). There is also a need to resolve the problem of a complicated and lengthy initiation of communication processes that are either too “tricky” for certain parts of the public or inconvenient for mobile users while on-the-move.

There is also a specific need for initiation of communication processes utilizing short activation messages which are focused on provisioning services and, in particular, repetitive services required for people on-the-move.

Currently creating new communication-process logic is performed by a skilled process builder, such as the service provider. There is a growing need for simple and friendly provisioning of advanced communication services for huge numbers of “technology illiterate” individuals who do not operate services beyond the simplest offerings of the current communication service providers, and consequently cannot access the much higher levels of personalized service quality. There is a need to enable such individuals to easily operate communication processes.

Broadband network technologies and in particular wireless networks are continuously developed and deployed for supporting communication not only between people but also between individuals or organizations and their properties placed in either “smart-homes” and “smart-offices” or in vehicles and on the communicating individual body. Such communicating devices can be used for a wide variety of applications, starting from monitoring-type applications, continuing with remote control of equipment and ending with smart pre-programmed per-event transfers of “heavy” bulks of information either as files or streamed to the owner of the communicating devices. As the number of such communicating devices per individual owner is expected to rapidly grow and constantly change during the near future, there is a need to enable simple and inexpensive remote operation of such communicating devices which are not limited by the physical location of their owner. As the communicating devices owned by individuals are expected to be supplied by various independent merchants or service providers, there is a need to enable a personalized programmable service, enabling individuals to add, subtract and personalize the operation of each device they own so that all devices will be uniquely and securely managed by a procedure fitted to both the communication device carried by the owner and the owner remote operation requirements.

The above mentioned trend of deployment of well-developed wireless broadband networks led to inclusion of “quick dial” keys embedded in new cellular phones for connecting the cellular phone user with specific broadband data providers. For example, recently Motorola reached a long-term agreement for inclusion of “hard-coded” keys on some of its cellular phone models for prompt connection of their phone users with either Google™ or Yahoo™ sites. Obviously, since the number of keys on any communicating device is limited, it is impossible to base personalized communication processes on “hard-coded” links that are connected to specific keys. Consequently, there is a need to enable communication devices' users to build a personalized list of “prompt connections” and translate it to “soft coded” keys on their mobile devices, allowing the device users to complete a detailed dialogue containing all the required personalized data transfer and communication instructions to the selected communicating entity by a real “single click”.

As most phones and mobile communication devices used today do not include communication-costs optimization modules that are designed to support communication users in saving communication costs, there is a need to allow communication users to obtain online communication cost reduction.

As more than one third of the global population and well above 60% of the consumers in developed countries are reachable through identified mobile devices, service providers are now closer to their potential customer base than ever before. However, during the last few years it was proven time and again that penetration of non-voice service provisioning over mobile networks is limited because its potential user-base is not ready to be serviced unless service activation is both prompt and personalized. Also, it was found that network operators prefer to limit their user independence in selection of communication and related services. Consequently, there is a need for centralized upgrade of mobile-network users' functionality by enabling them to activate advanced processes supported by alternative networks, service providers and consumers needs. Processes such as repetitive requests for specific services on one hand, and instantaneous voting on the other hand, are simple examples of the variety of applications that can be adopted by network users with or without simple personalization for being activated utilizing processes that require seconds from initiation to completion.

As the number of mobile communication users roaming between different networks, and particularly when using multi networks-capable communication devices is rapidly growing, there is a need to centralize monitoring of communication links for reestablishing connections to users upon network disruptions. Automatic communication channel tracking, channel availability and reconnection via available optimal communication channels is especially important when users are in motion and are focused on driving or walking.

### SUMMARY OF THE INVENTION

The present invention disclosed herein enables an individual user of a personalized communication web server (PCWS), and other entities that are authorized by such user, to submit a very short activation message (AM) to the server for activating a preprogrammed complicated process, uniquely identified by the AM, and combining switching, routing, searching, finding, connecting and managing communication sessions of one or many communication communicating entities. Activation Message submission is conducted utilizing wire-line or wireless communication devices, preferably, but not limited to identified devices that can be used for prompt recognition of the process initiator by the PCWS, over any network accessible by the PCWS for conducting either voice or data or video sessions.

The present invention further discloses a new personalized switching, routing and communication web server system (PCWS) for automated communication session management, enabling PCWS users to build, prior to actual usage, on their individual PCWS site, a multiplicity of different modular automatic communication processes, governed by predefined communication rules for optimally connecting communication partners and exchanging predefined or real-time created information. Communication partners may include the user and any communicating entities owning identified communication devices, accessible by the PCWS through voice, data, and video type networks. Once created, declared operational and stored in the user PCWS site, such PCWS automatic communication processes can be initiated by sending a very short activation message from an Identified Authorized process Initiator, using a communication device, preferably but not limited to User's Identified Device or Authorized Initiator Identified Device to the PCWS, uniquely identifying the process to be activated and authenticating the authorization to activate it.

In accordance with certain formats of the invention, Activation Messages (AM) sent by an Identified Authorized Initiator (IAI) to the PCWS, through one of the PCWS links to PSTN, Mobile and IP networks, should include two building blocks, 1) Authorized Initiator Identifier (AII) and 2) Process Identifier. The AII, used by the PCWS to identify the user's personalized site, which contains the personalized preprogrammed processes, can be the identifier attached to the IAID in use. Such identifier is either the Calling Line Identifier (CLI) in the case of PSTN or Mobile Network systems or the IAID IP number in the case of routing networks, or different set of passwords that are required either instead or “on-top” of the IAID identifier, per process specifications. The Process Identifier, used by the PCWS to identify the preprogrammed personalized process within the personalized process list, is an alphanumeric code or graphic code, which can be, for example, as simple as the ID (Identification) of the PCWS communication channel identifier used by the IAI for sending the AM to the server. The PCWS, upon receiving the AM, decodes the Authorized Initiator Identifiers and the Process Identifier (PI), selects the preprogrammed personalized process and activates it per preprogrammed process specifications.

The present invention enables PCWS users to predefine several sets of communication rules, relating to their active UIDs or to other IAIDs, under which process initiators will be connected by the PCWS to other communication partners upon activation of PCWS managed processes. In accordance with the current invention switching a module of an active set of communication rules to one of the other predefined modules can be done either automatically by the PCWS, following an automatic change of circumstances such as time and date, available communication channels or user available budget, or by a user-originated AM, pointing at a preprogrammed process of activating specific module within the set of communication rules, or by a user log-in to the personalized site and selecting the sub-set of active modules relating to the communication rules.

The present invention teaches how PCWS users are capable of using the system infrastructure and its flexible programmable processes to create large amounts of different processes that are based on Communication Rules (CR) and search algorithms, related to Users, Users Identified Devices, other Identified Authorized process Initiators with their Identified Devices, Communicating entities Identified Devices and PCWS Modules. Without losing generality, the flexible versatility of the enabled method and communication applications can be demonstrated by an example related to user, or other authorized process initiator, activation of PCWS automatic set-up of “many to many” predefined group connections, such as a conference call between communicating entities connected to different communication systems, utilizing versatile predefined communicating entities identified devices (CEIDs) including land line PSTN phones, mobile phones, network (e.g. IP) connected audio/video consumers devices and different users on different Internet Protocol (IP) based systems.

The user preprogramming tasks when setting up such a preprogrammed Group call with specific predefined communicating entities includes the following steps: Securely enter the personalized PCWS site.

Select “Adding New Process” and assign new Process Identifier (PI) out of PCWS non-assigned options.

Select authorized process initiator table and define each of the initiators by name and all his/her relevant applicable identifiers.

Select communicating entities table and define each of the conference communicating entities by name, and all his/hers relevant applicable CEID's.

Define the Search, Find and Connect processes' priorities for connecting each one of the IAIDs and CEIDs for each of the participants. In case of multiple devices for the same participants define which are the ones that should be called first based call parameters such as schedule.

If a preprogrammed process is set to be activated within a predefined delay after sending the AM to PCWS, define, if required, PCWS originated notification on the upcoming call to communicating entities via selected communication channels and formats (such as SMSs, E-mails, voice messages) together with expected communicating entity confirmation, if applicable. If specific participants of the call are mandatory to its operation, assign an index to all such participants included in the process, guiding the PCWS to establish a connection with at least one of their CEIDs prior to connecting other non-mandatory participants.

When ready to annex the new process to your preprogrammed process, command PCWS to transfer it to “operational process table.” In response, PCWS will notify all process participants on the creation of the new process and will send them specific process details related to each one of them, enabling them to accept, reject or request modifications.

PCWS, upon receiving summary of confirmations or rejections from participants, will automatically notify the process creator and modify communication device priority and other communication rules based on the communicating entity's confirmation and will update the active process logic, or will deactivate process and notify creator accordingly if process is not confirmed by mandatory participants.

Step h. above, ends process preprogramming and fine-tuning phases, and the preprogrammed Group call process can be activated by a short AM when sent by authorized initiator to the PCWS, unless the confirmation process of step i. resulted with automatic deactivation.

Pre-activation testing of the process can be requested onsite for emulating the AM decoding and checking communicating entity response to the test notification. Online Activation includes the following steps:

Authorized Initiator sends an AM as preprogrammed to PCWS including all required user identifiers.

If process includes communicating entity confirmation to conference notification, initiator waits for PCWS report and if communicating entity failed to confirm decides between “Cancel”, “Retry” and “Continue” AM's. If communicating entities who are defined as mandatory for operating the call cannot be reached the “continue” AM may become invalid.

Initiator waits to be connected by PCWS per predefined connection rules and timing and receives process activation report at the beginning (announcing the connected communicating entities. If communicating entities who are defined as mandatory for operating the call cannot be reached the report may be call cancellation.), during (announcing dropped and re-established connections) and by the end of the call. If disconnected, participant waits for PCWS to reconnect relevant device or send a “terminate” message to the process manager.

In accordance with certain embodiment and processes of the current invention, PCWS can allocate single and unique Process Identifiers per user such as Internet Protocol number or if applicable a telephone number, which is assigned as a Process Identifier (PI) for the process “connect me to the owner of the PI”. Such a process can be activated by any user of a communication device, including non-PCWS users. If activated, the PCWS will initiate the following connection process:
a) If a caller belongs to a filtered caller group—process the call based on the filter rules, (as an example: terminate the filtered Group calls) if not
b) Check if Called ID (through CLI) belongs to a non-default group. If yes activate specific connection rules set for the group, and if not
c) Connect caller to User, utilizing predefined default connection rules.

In accordance with certain embodiments of the current invention the PCWS is set to support different types of users and user related entities. Four basic types of PCWS user related entities are defined as:
1) Active User (ACS) who is entitled to own personalized sites within which ACS can preprogram processes and later activate them by sending an AM uniquely fitted to the activated process as stored in the ACS own site. Such users can also be communicating entities of processes, which are preprogrammed by other ACS of the PCWS.
2) Identified Authorized process Initiator (IAI)—an entity defined by an ACS on a per-process basis, authorized to activate a specific process by sending the relevant AM but not authorized to update the process details, excluding, when authorized, its own IAIDs and related communication rules.
3) Semi-Active User (SAS) who is entitled to own a personalized site within which SAS can preprogram processes having process identifier and content but the communicating entity is the SAS itself with its list of UIDs. SAS processes are submitted to a general share-ware process library, for the selective adoption by ACSs. SAS can allow non-users to partially activate certain SAS process. Such cases should be defined by the communication rules assigned to the process (for example, “Voting processes” that will be discussed later). When SAS processes, are adopted by an ACS, they can either be used “as is”, utilizing the SAS PIs and adding the ACS UIDs for activation purposes, or else ACSs can slightly modify the process content, within limits authorized by the creating SAS. Examples of typical SASs are service-providers (SPs) with their Service-Provider Identified Devices (SPIDs) who can offer their predefined services to ACSs by enabling the ACSs to adopt the activation of such services, with the minimal burden of selecting the pre-edited process, including all its operation details out of the PCWS general process library.
4) Passive User (PAU) which is created by and uniquely linked to a specific ACS ID and site, can own preprogrammed processes having their own PIs and content. The PAU with its identified devices is always the communicating entity of such processes and the ACS creating the processes for the PAU, together with a predefined list of other ACSs, are the only entities authorized to activate PAU processes. The only communication activity initiated actively by the PAU is transmitting reports or information in forms of files or streams with regards to processes activated by the authorized ACSs. Typical examples of PAUs are communication devices linked to equipment such as modules of “smart-homes & offices”, and mobile equipment such as personal monitoring system, communicating vehicular modules, cameras, or different types of audio and video recorders and players and other remotely activated devices.

According to the current invention the PCWS system is capable of being programmed to enables different type of privileges assigned to different communicating entities in general and communicating entities who are users in particular. The privileges may include, among others, access to PCWS programming functions and access to share-ware libraries. The libraries may contain preset and fine-tuned sets of Communication Rules (CR) and preprogrammed communication processes that can be copied for inclusion within users' personalized sites. Users can adopt the share ware processes as-is, or with limited authorized modifications, such as, but not limited to, authorization to activate processes, certain rights to receiving notifications, personalizing the process content and other types of information managed by the PCWS during the processes' creation and activation.

### BRIEF DESCRIPTION OF THE DRAWINGS

The invention will be described in detail with the aid of examples and by referring to the appended drawings, wherein:

FIG. 1 is a general diagram of the connection between the personalized switching and routing communication web servers (PCWS)—(100) of the current invention, the users computerized systems (104), for accessing the PCWS user site via IP based networks (101) for the purpose of preprogramming personalized processes, the user mobile devices (102) for submitting activation message, via Mobile networks (103) and variety of communicating entities devices and corresponding communication networks of the type of landline Phones (108) and PSTN (107) network, Mobile devices (106) and Mobile systems (105), Internet based devices (110) and networks (109) as well as other identified passive and active equipments (112) connected to communication networks (111) accessed by the PCWS (100).

FIG. 2 is a block diagram describing another embodiment of the PCWS system (100), which enables service providers to offer a “single click” service request processes from their web sites (116), by advertising the processes on either displays (115) connected via systems (114) to network (109), or via non-electronic signs (117) or via inclusion of the preprogrammed process in share-ware process-library managed by the PCWS and opened for relevant PCWS users for adoption and inclusion within their personalized sites. PCWS Processes are programmed via computerized systems (104) and/or mobile devices (102) and users Activation Messages can be submitted by devices (102, 104, 106, 108,) via networks (103 101 105 107).

FIG. 3 is a general flow chart of “Subscription and Personalization process” followed by users logging into the PCWS sites and the corresponding steps followed by the PCWS.

FIG. 4 (a, b, c) is a general flow chart of an “activation process” describing a PCWS user or other Identified Authorized process Initiator (IAI) steps for submitting an activation message for a PCWS preprogrammed process and the corresponding steps followed by the PCWS.

### DETAILED DESCRIPTION OF THE PREFERRED EMBODIMENT

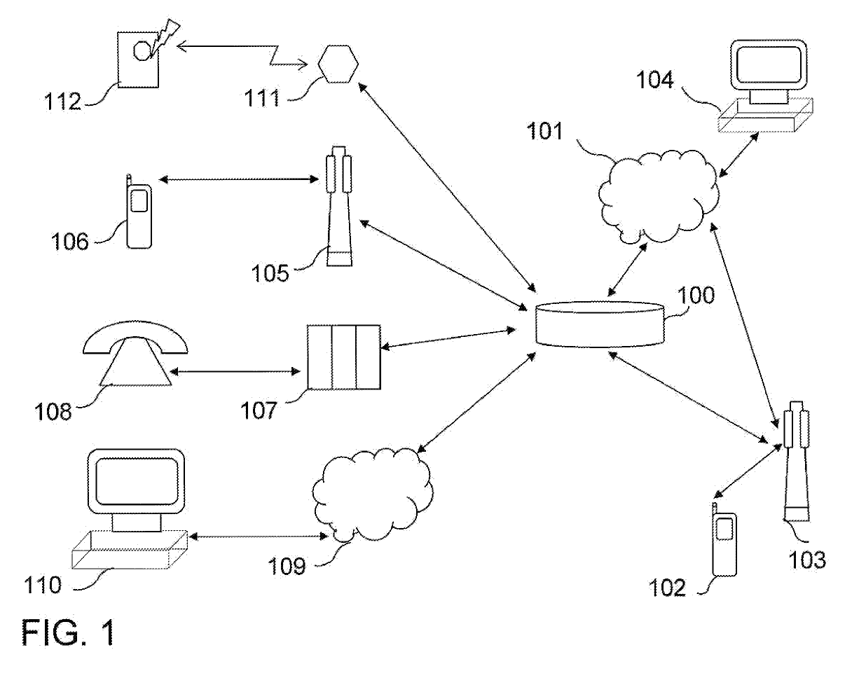

FIG. 1 is a high-level block diagram of the basic elements of an exemplary communication system as contemplated herein. The Personalized switching and routing Communication Web Server (PCWS) system 100, is connected to communication networks such as the Internet 109 and 101, the land line telephone systems 107, the mobile systems 105 and 103 and other proprietary networks and communication systems 111.

The PCWS programs enable the execution of search, find and connect processes among communicating entities' and users' communication devices 106, 108, 110, 112, 102, and 104 by activating the switching and routing processes on its software programmable switch and router (100) according to processes defined by the users on their PCWS sites (100).

The software may be provided as a computer program product which may include a computer-readable medium having stored thereon instructions, which, when read, cause a computer (or other electronic devices) to perform a process or method. The computer-readable medium may include, but is not limited to, floppy diskettes, optical disks, CD-ROMs (Compact Disc-Read Only Memories), and magneto-optical disks, ROMs (Read Only Memories), RAMs (Random Access Memories), EPROMs (Erasable Programmable Read Only Memories), EEPROMs (Electromagnetic Erasable Programmable Read Only Memories), magnetic or optical cards, flash memory, or other type of media/computer-readable medium suitable for storing electronic instructions. Moreover, the software may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a computer-readable medium. In some embodiments, some or all of the instructions of the software may be installed on more than one computing device to perform the method using distributed computing techniques.

In order to become user and set up communication based processes on the PCWS website, the PCWS users access the PCWS 100 system site via the Internet Network 101 and 109 using fixed and mobile computerized devices 104, 110, and 102. Users program their personalized PCWS site with communication processes according to well defined communication rules that enables the PCWS processes to search, find, connect and execute information transfer to communicating entities' communication devices such as Mobile devices 106 via mobile networks 105, landline devices 108 via public phone networks 107, Internet based computerized devices 110 via the Internet network 109, and other communication based devices 112 connected to proprietary communication network such as satellite phones, remote measurement or monitoring equipments and others passive devices.

PCWS users, define at their PCWS sites their User Identifiers (SI), and the identifiers of Other Identified and Authorized process Initiators that the user would like to include in their personalized processes including approved user-names, relevant pass-words and the communication devices' Identification numbers, with which they intend to participate in PCWS managed communication processes. The mobile and fixed (such as land line phone) communication devices 102, 106, 108, 110 of users and other Identified Authorized process Initiators' (IAI), are called User Identified Devices (UIDs) or Identified Authorized process Initiator Devices (IAIDs) respectively and are used for submission of processes Activation Messages (AM) to the PCWS personalized sites. The same UIDs are also considered as communicating entities Identified Devices (CEIDs) when accessed by the PCWS processes for connecting the UID owner to a certain communication process initiated by either the same user or by other user.

Devices Identification Numbers include phone numbers identified by the Caller ID and Internet Protocol numbers (such as IPV4 and IPV6 ) or any series of characters that uniquely identify a communication device when it connects to the PCWS through a communication network. When a communication device is connected to a PBX or gets assigned a different address by the local network, an additional identification process is incorporated during which the PCWS may request an additional data in response to a non-identified AM for identifying the process initiator. When user or IAI identifiers or UIDs or IAIDs unique Identification Numbers such as caller ID (CLI) or Internet Protocol (IP) number are received by the PCWS, the PCWS uses it to authenticate the process Initiator identification and their linkage and authorizations related to the Users' PCWS personalized sites containing the activated process.

The Activation Message also contains a unique Process Identifier (PI) that is used by the PCWS to identify the preprogrammed process on the user PCWS site. Once identified the PCWS can activate and execute the process. Specifically the Process Identifier (PI) can be as simple as the channel identifier of the connection channel used by the UID or IAID in order to connect to the PCWS site.

In such cases, the process Identifiers (PI) can be stored in the authorized identified devices contacts book or any other “book” that can store the PI logically, making it easily accessible to the process initiator. Moreover, the stored process identifier can be given a “title” that identifies the content it is designated to activate on the PCWS. Under these circumstances, PI selection can be based on selecting the required, stored “title” linked to the PI and by a “Single Click” (“send”) submit the AM, or alternatively utilize voice-activation whenever applicable to prompt the stored PI and send the AM to the PCWS.

In the case of frequent usage of certain processes, or in the case of processes that must be initiated in a prompt manner, users or other IAIs can use the existing features of their identified communicating devices and connect such processes stored in the devices' memory to certain keys on the devices' key-pad or “soft-keys” on the devices' default display, thus creating “speed dial” or “one touch” connection (depending on a device's features) for submitting the said AMs to the PCWS. Other alternatives for sending the PI to the PCWS can be through any non-voice type channel such as any text (for example SMS, or e-mail) or graphic (for example MMS, Still-Picture, or video camera when are applicable to the relevant communicating devices). Consequently, the authorized initiators can send he short Activation Message; from their Mobile devices 102 via the mobile communication networks 103 using direct connect to the PCWS or via the Internet network as described by 101. Standard Phone devices are connected via the PSTN (Public Switched Telephone Network) network 107 can send the activation message by dialing the number from keypad or from memory.

This unique approach of Activation Message (AM) as described by the current invention allows minimal set-up time as well as minimal or no connection time for the submission of the Process Identifier, thus saving the Activation Message connection cost via communication networks such as mobile (103, 105) and land line (107) networks and allowing the PCWS to optimize both economically and technically the communication session parameters.

Thus the current invention defines a new concept of short Activation Message (AM) of preprogrammed process, wherein process initiators use their mobile or land-line communication devices for a “Single-Click” mode of activation process, simply by selecting and sending a short code such as activating a specific identified communication channel of the PCWS for a unique identification of the communication process on the user personalized site, wherein that site is uniquely correlated with their authorized initiator identifiers.

In another preferred embodiment of the current invention the process initiator connects to the PCWS system via the PCWS access number. Such a number could be a standard telephone number of 1-800 type number. the PCWS identifies the initiator, via the communication device identifier or if required by approved access codes, connects the link and enables the process initiator to submit PI while the communication device is connected to the PCWS.

While being connected to the process initiator, the PCWS can activate an Interactive Voice Response (IVR) system enabling the IAI to select a process from the relevant personalized site by responding to voice selection offering. The PCWS IVR can also allows Initiators, during authorized accessing of PCWS site and selecting a predefined process, to fine-tune the selected process by modifying parameters that are authorized for modification for the relevant IAI, either permanently or only for the next activation.

It should be noted in this regard, that when an authorized initiator is not the process creator, all modifications are limited to authorizations as defined by the process creator during the preprogramming process. Such limitations apply also when the Initiator who is not the process creator is a PCWS user. In such a case, as described in the flow chart below, the PCWS exports the process from the creator-site to the personalized site of the other user. The imported process at the other user-site includes the appropriate change-limitations as imposed by the preprogramming process. An example for such fine tuning of a ported processes, is the modification of a predefined group call (conference call) process that needs to be redefined by adding and deleting certain CEIDs through an on-line responding to IVR instructions.

The PCWS IVR can allow the users while accessing their PCWS sites to create an “ad-hoc” new communication process. For example, users can select an option of accessing their “CEIDs Address Book” information, and then select certain CEIDs numbers from the address book, inserting the numbers to a selected communication process, such as “creating connection to all selected CEIDs at certain timing” and activate the process. Once a newly defined “ad-hoc” process is created with the newly inserted CEIDs and activated by the user, the PCWS will execute the fine tuned process as requested. Records of such “ad-hoc” process can be saved for future activation based on the same parameters or for future modification of the last saved set of parameters defining the process.

Ad-hoc activation can also be based on online selection of a process from the share-ware library list which was not pre-included in the user site and sending its PI together with the user's identifiers to the PCWS. As the share-ware processes are built to require minimum manual personalization, some can be sent from the presented library list “as-is” where all required personalization is fully automated. Other share-ware processes may require minor fully guided insertion of parameter prior to being ready for transmittal.

Activation Message can also be sent by users when they are logged to their PCWS system site via the Internet using their computerized devices such as 104, 110 and 102. While being online the user can easily define a new process, or modify an existing process, save it to the system and upon receiving PCWS approval, immediately activate it or set a timer for a delayed activation of such a process.

After sending an AM user and other IAIs can receive online reports regarding the process progress and can also decide to activate other processes related or complementary to the initially activated process. Such activation of a chain of linked processes can be, but is not necessarily, managed utilizing different communication devices connected to the same initiator for each element of the chain.

For example, an initiator can select a specific device to activate the first element of the communication-process-chain and later continue the activation of other elements of the chain utilizing different devices as optimally required due to network accessibility, type of information transferred, or any other relevant parameter.

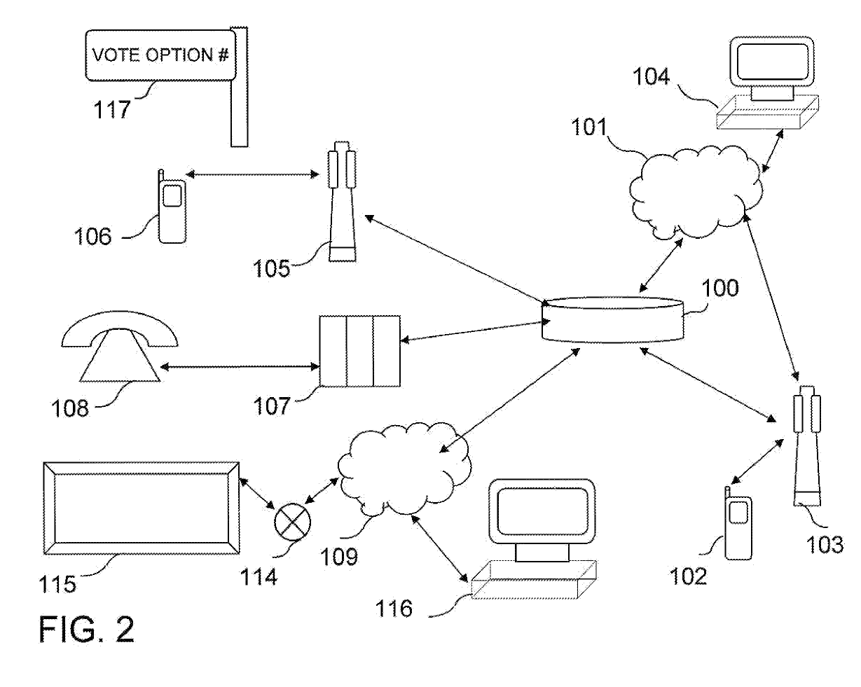

FIG. 2 is a high-level block diagram of the basic elements of the Personalized Communication Web Server (PCWS) system described in FIG. 1. FIG. 2 teaches another embodiment of the current invention where service providers use the PCWS system, in order to offer their services and products to customers. The numbering scheme of FIG. 2 is the same as the one used for FIG. 1 when designating the same elements of the system as explained already in FIG. 1.

The Personalized switching and routing Communication Web Server (PCWS) of FIG. 2, system 100, is connected to communication networks such as the Internet 109 and 101, the landline telephone systems 107, the mobile systems 105 and 103. As an example for broadcasting information to consumers an electronic media channel 115 is connected to the PCWS system via IP network 109. 115 can also be a TV displays or Radio channel receiving broadcast information, such as advertisement and connected via systems 114 such system could be a CATV, Direct satellite broadcast or off-air Broadcast system. The service provider exposure to the public can also be any non-electronic physical object uniquely marked by a service or data provider with an alpha-numeric or graphic mark defined later as object-identifier such as billboard 117.

Authorized service providers can create and publish service-provisioning processes using a link between their PCWS site (100) and alternative web sites 116. The service providers' processes are preprogrammed to connect system users, responding to service offers by sending a published service providers' Activation Message (AM) which includes the appropriate Process Identifier (PI) to their web site 116. Such processes can be, for example, provisioning of an audio-information related to a marked object or service, or sending service or product related data to the communicating entity's e-mail. Thus AM can activate a service providers' predefined processes delivering services to any communicating entities or known entity.

A general type of such a service is an offering of a product or service via interactive or non-interactive advertisement on a TV or Radio broadcast channel, Internet Channels, electronic displays or on non-electronic signs. During the product advertisement campaign, an Activation Message, such as a 1-800 type number, a pre-set “short-alpha-numeric code” or a pre-set graphic mark, which is designated for an access to the PCWS hosted service provider site, is published so that viewers can connect to the PCWS site, using their Mobile or landline phones, and activate the process associated with the published AM. When system potential users who are exposed to certain information or advertisements on an electronic media channel 115, such as a TV or other non electronic signs 117, decide to respond to a certain advertisement or other marked services offered, they connect to PCWS via the service published AM number. The PI for such AM can be assigned by the Service provider or automatically by the PCWS from a list of communication channels available for connection to the PCWS system or redirected from the PCWS to the service provider independent system.

Upon receiving the AM (which includes the Initiator's identifiers and the Published PI) the PCWS identifies the IAI and activates a pre-defined process called Service Request. In its simplest form the communication process embedded in the PCWS can switch the incoming message to the service provider website for further handling. Such a process may also include registration of the incoming call, information transfer to the caller such as an announcement of certain alternative selections via menu operated by DTMF keyboard or voice activation of certain options that are available on the PCWS hosted service provider site. In cases of prior personalization of the service, the AM can also activate personalized transfer of information in different forms such as audio, e-mail, video, or pointing at specific selections at service provider preset menus which can be remotely managed by the system user using the communication device and pre-programmed navigation options within the web-stored files.

Many other processes may be incorporated in the PCWS hosted service provider site or referred sites 116 with commercial applications, which are activated based on the in coming AM. The AM can activate an IVR system, or video session, and when required, route the call to a human call center if the service request requires “fine-tuning” by the system user beyond the automated remote management of the audio, data or video-files. The type of personalization required by the user or an un-subscribed user, may define for example the preferred networks for connecting the user to the PCWS, the language used to communicate between the user and the PCWS, and an exact location of service provisioning if not included in the predefined PI. When the communication devices in use are recognized by the PCWS, the system can initiate a predefined communication process based on the system user formerly defined profile.

Without limiting the generality of the above-proposed PCWS hosted service provisioning, an example for service provider service can be a mobile-payment for parking services. The service provider, operating a municipal curb-side parking or a parking lot, publishes the alpha-numeric codes or graphic-signs which act as Process Identifiers (PI) for the parking site “start” parking time-message while another general-type “END” message is used to mark ending of the parking session. The published process is stored in the PCWS service provider share-ware library for later adoption and, if required, authorized modification by the potential users. The subscribing car drivers are expected to send an AM from their Mobile Phones, or from any alternative means of communication enabling a link with the PCWS when parking their car at the relevant sites included in the published processes.

The standard publicly published AM is expected to be sent by keying and sending the PI code from mobile phone or alternative IAIDs or by keying and sending both the Authorized Initiator Identifiers and PI when using communication channel which is not an IAID. This PI may include only few characters recognized by the SS7 system to be directed to the PCWS or a communication channel identification number, or may be embedded in a standard short message such as but not limited to IM, SMS, MMS etc.

In the example of mobile-payment for parking services, when the IAID or alternative identifiers' signals are accepted by the PCWS, the centralized system identifies the driver user ID, connected with a specific car-license plate, and the “Start parking PI” identifies the service provider's parking site. The PCWS process may also include activation of gate opener once an AM with recognized user ID and the “Start parking PI” reached the PCWS parking process and was decoded as required by the lot operator. When the system user identifiers are already registered on the system and the associated payment mechanism is well defined, (such as when an active credit card or debit account exist and can be charged by the system), the system can automatically start charging the parking rate per period session. Upon departure from the parking site the driver sends the “END” AM, decoded as “Parking Session Termination PI”, informing the PCWS service provider site (or other service provider related sites) on vehicle departure and triggering necessary gate opening mechanism when applicable. The “Parking Session Termination PI” will initiate a process that will end the parking time-measurement and initiate billing and invoicing processes by e-mail SMS or other predefined information channel. The AM for entering the parking site and departure could be stored in the driver mobile phone memory under process names as defined by the subscribing driver during personalization process and be recalled for activation whenever parking session starts or being terminated.

Unlike related technologies that are employed in different locations, the PCWS system and the personalization capabilities embedded in it for both the system user and service provider, can offer superior ease of service provisioning, particularly in the case of repetitive use of the same service by the same users. For example, personalization of the service by the subscribing drivers during preprogramming may also include, customization of the service request, including changing of the published PIs if required, for enabling a simpler and more intuitive storage of the AM within their IAID memory and a real “single click” activation, for example an AM called “office parking,” or if required a personalized encoded voice activation of the service. Such personalization may also include a request for notification message, T minutes prior to maximal parking session end, or before expected change of parking rates, or switching between means of payment at certain periods of the week.

Personalization of the process by the lot manager may include associating different parking parameters to different users. Such association may include, for example, maximal allowed parking time, relevant parking rates, associating the parking session to a group-activity including monitoring parking parameters that are counted both individually per driver and cumulatively for the entire group, or activating a digital camera for photographing a car's license plate upon receiving drivers AM at the gate for secured correlation between paying user and registered vehicle.

In another embodiment of the current invention the PCWS enables its user communities as well as individual users to share and correlate information or to share communication-process logic which relates to preprogrammed PCWS processes. The infrastructure embedded in the PCWS for provisioning of the sharing services is based on two major components—the shareware process library and the software supporting process design and qualification enabling process designers to speed up their tasks and to pre-verify the acceptance of the newly designed processes by the PCWS screening tests.

The share-ware process library is categorized to sections by menu-tree splitting of its content. Such categorization enables fast search for a required process-type or process-content as well as activation of screening tools by users enabling them to block or control their exposure to certain parts of the library. The processes stored in the library by skilled users or the PCWS itself can be pre-qualified by the PCWS for user adoption. Such prequalification can be based on software tools embedded in the share-ware infrastructure and open for process designers to iteratively test their newly designed process prior to submitting the process for the PCWS qualification. Other design tools which are embedded in the library infrastructure include structural design of new processes enabling designers to start process creation from its very basic but mandatory components, or use an existing library process which is authorized by its creator for redesign or modify by others.

The software tools and communication mechanisms allow the authorized user and the personalized web-based communication server to verify that a newly created personalized preprogrammed process is qualified according to at least one of the following: authorizations given to the authorized user; authorizations given to authorized process initiators; communication process and communication rules defined by a process creator when compared with limitations of networks to be used by the created personalized preprogrammed process and limitations imposed by network operators; communication process and communication rules defined by the process creator when compared with the technical capabilities of communication devices to be used by the created personalized preprogrammed process; the communication process and communication rules defined by the process creator when compared with communication rules defined by the communicating entities include in the personalized preprogrammed process as known during a creation phase of the personalized preprogrammed process or received in response to distributing personalized preprogrammed process details to said communicating entities; a successful testing of the created personalized preprogrammed process; qualifying procedures of the created personalized preprogrammed process by entities planned to manage and maintain it once activated; qualifying procedures of the commercial terms; qualifying procedure of the rights related to the creator of the new process when compared with the rights of former process creators.

Once a newly designed process is submitted for qualification prior to storage in the share-ware library, and found qualified, the PCWS assigns such process a process-identifier taken from an unused stock of identifiers managed by the PCWS, approves its storage category and stores it in single or multiple sections of the library, depending on its exact category definition.

The share-ware concept enables service providers or other communication process designers to generate new processes for storage in the PCWS process library for the general use of PCWS users of for the use of qualified specific users. The library usage rules allow the users to include the share-ware processes in their sites as well as to personalize such processes for optimizing their content and/or formal definition to their exact personalized requirements while sending the short AM pointing at such process. Once personalized and saved on their sites, users can remotely activate the adopted processes utilizing either the predefined library-based AM and PI or the personalized version of the required identifiers.

Two main alternatives for using share-ware libraries are as follows:
1) Content driven usage—In this case the user utilizing the share-ware is mainly interested in the information transferred between the process initiator and the communicating entities. Therefore, once copied to the user-personalized site, the personalization of the copied process is primarily focused on optimizing the transferred content between initiator and communicating entities and maintaining the communication logic as originally proposed. An example for such usage is adopting service-providers' preprogrammed processes. The user utilizing the processes may be required to define the optional UIDs or IAIDs that may activate the process (the default is always all approved UIDs and can be embedded in the adopted process automatically by the PCWS) and when the service is location sensitive, an exact definition of the sites for the service delivery is mandatory (default can be the user main address in the subscription form and can be embedded in the adopted process automatically by the PCWS). On top of the mandatory personalized components of the adopted process some additional fine-tuning may apply. For example, when user adopts a preprogrammed process prepared by a service provider of home-delivered food, say pizza, the personalization may include fine-tuning of both the delivered meal (out of a menu proposed by the SP) and the means of payment (out of a limited option-list proposed by the SP). In general, both a user or an authorized service provider can create default-preprogrammed processes on their PCWS sites, which offer “add-ons” to already-existing default services, and are stored as new processes in the share-ware library. Other users can select the preprogrammed default services, or the revised ones stored in the library, and add them to their personalized sites for remote activation using their own identification alternatives.
2) Communication Logic driven usage—In this case the user utilizing the share-ware is mainly interested in the communication-process logic as structured by the designer of the library-process. Therefore, the personalization of the copied process is primarily focused on selecting the communicating entities for the process through their CEIDs, and optimizing the communication scheduling as well as, other communication rules connecting the relevant CEIDs through personalized prioritization and enabling online control of the process while being activated. An example for such usage is different type of group calls that can be designed for different communication architecture enabling the users to select the best fit for their personal requirements.

Library-processes that are considered a mix of content-driven and communication-logic driven can be implemented by personalization of all parameters that are relevant to both categories. The processes of all categories, once copied from the library, filled with all mandatory and elective personal data, can be activated when declared operational by the user, utilizing either the exact AM proposed by the process designer, or a new AM selected and defined by the user during personalization when such a change is authorized by the process creator.

In another embodiment of the current invention, the PCWS can enable publishing of new library processes by sending notifications to one or more of the Users' UIDs notifying them about the availability of the new processes and general terms and requirements for the adoption of each one of such processes. Users can personalize the “filter” for defining the types of processes for which they wish to receive such notification. Such filters, which are based on the process library categorized sections, can block transmittal of notifications which are not included in the user's predefined interests. Also, upon receiving a notification, user can respond with a different level of rejection messages starting with specifying no-interest in the new process to a complete blocking of either the proposing service provider or of the field-of-interest to which the new process belongs. Users can also actively reject specific processes proposed by the PCWS, by blocking attempts to activate said default processes by any of their identified devices. Such option could be useful in the cases of preventing certain UIDs from activating costly services prior to a specific active authorization.

Voting processes are one of the simplest examples of the share-ware type processes related to another embodiment of the current invention. “Voting processes” can be included in the PCWS share-ware library by the PCWS operator, co-managed in conjunction with, or on behalf of certain service providers, or information collectors. Such type of share-ware processes are based on Processes Identifiers (PIs) that preferably but not necessarily, should not be modified by the users, or used for any alternative PCWS based process. Each of the relevant PI(xy) includes the content—“Voting for Option (xy)”. The PCWS can assign any number of PIs reflecting equivalent number of voting options, say, 1 to 99. By adopting the entire group of Voting Processes. A user of IAI can become a potential voter for practically any number of voting sessions that are managed serially, as well as multiple number of sessions managed in parallel, having accumulated number of voting options smaller than the total number of voting processes offered.

According to the current invention a list of the “voting processes” can be saved in the memory of one or more of the relevant UIDs or IAIDs and particularly in mobile UIDs or IAIDs, the user or Authorized Initiator can complete fully identified voting process, including the identification process required for computerized elimination of more than single voting per person. Thus the voter can vote within very short period of being exposed to a request for voting session. The only instruction required while presenting a voting session or a poll to the public is—“select” vote option by number (or alphanumeric) and “Send” it.

For example, voting for the MVP (Most Valuable Player) during a ball-game, or for a horse during a horse-race, or any voting for a contestant marked by a number can be as simple as “select the MVP (or relevant contestant) shirt number as your voting option and send”. Another example for voting during broadcasted events, such as, voting while watching a Trivia online TV-game—can—“select the right answer by option number and send” or “Guess the winning number by voting option and send”. As users are registered by geographical address, and since all votes or polls are given a well defined time slot and sometime limited to residents of a certain region, PCWS based voting applications can sell their services to all authorities or service providers and also present and if required display online the accumulation of actual results depending on different statistical parameters such as voters-region or any other user characteristics which is part of the subscription data given away upon registration.

Other examples of selected alternatives represented by the process identifier in a voting message include at least one of the following: authorized user pre-selected, general purpose voting messages, included in a personalized library at the personalized communication web-based server site as up to “m” preprogrammed processes of selecting item “n” out of “m”; personalized communication web-based server pre-selected, general purpose voting options inserted into a share-ware preprogrammed process library as “m” preprogrammed options of selecting item “n” out of “m”; or personalized communication web-based server allocation of voting options' identifiers associated with the activation of a specific voting process including the process identifier being alpha-numerically correlated with a marking on the selected option, wherein the personalized communication web-based server allocated identifiers cover a full range of the voting options, enabling sending the selected option number by a single short activation message. Other aspects of the voting process include: an online presentation to potential voters of the selected voting options and their correlation with the activation message as part of the process activation; combining personalized communication web-based server resources and voting organizer needs enabling alpha-numeric correlation between marking on the selected option, and the personalized communication web-based server allocated identifiers, covering the full range of the voting options, and enabling sending the selected option number by an intuitive short activation; analyzing the accumulated voting messages, enabling online elimination of multiple votes submitted by the same authorized user for automatic disqualifying of authorized users, exceeding the maximum allowed number of voting messages per user; responding immediately to voters with subsequent questions relating to the voting process or to their specific vote by relying on an online analysis of the voting messages; presenting and displaying online the accumulated voting results, wherein said results may depend on typical voters' parameters including geography, voting time, and other parameters that can be used to classify the voter, or analyze the voting statistics, including broadcasting or submitting the results through other media channels capable of presenting the analyzed results numerically or graphically; distributing the voting results to the relevant voters upon completion of specific stages of the voting process; utilizing the stored parameters in the personalized communication web-based server to generate data and related fees that are assigned to a service provider utilizing the personalized communication web-based server general purpose voting method and process, wherein activation messages fees are calculated based on a predefined fee formula, linked to at least one of the following: number of voting activation messages used; a period of time allocated for the service provider for using such general purpose activation messages; a peak capacity and total number of expected voters during the period of time; an actual number of activation messages received and processed during an activation period of the voting process; or a type of information feedback transferred during and after a voting session to the service provider organizing the voting session and the voters.

It should be understood that the system of the current invention can be implemented in a distributed architecture, comprising a plurality of communicating entities, operating a plurality of communication devices connected to a plurality of communication networks and servers as shown schematically in FIG. 1 and FIG. 2. Thus the current system is capable of at least one of the following: operating a plurality of personalized communication web-based servers utilizing a plurality of sites in a distributed network; distributing the stored personalized preprogrammed process among a plurality of sites in a distributed network; receiving the activation message by a plurality of personalized communication web-based servers when said message is submitted serially or in parallel through a plurality of communication channels; distributing the validation of the activation message and the authorization of the activated personalized preprogrammed process among a plurality of servers; managing and maintaining the activated personalized preprogrammed process by a plurality of personalized communication web-based servers.

It should also be understood that the system of the current invention is capable of one or all of the following: enabling information transfer between communicating entities per personalized preprogrammed process requirements and communication rules; controlling set-up of passive users participating in a personalized preprogrammed process prior to activating the personalized preprogrammed process; establishing communication between active and passive users during an activated personalized preprogrammed process; analyzing, authorizing and responding to activation messages submitted by authorized communicating entities during and in relation to an activated personalized preprogrammed process as part of the preprogrammed authorizations granted to said communicating entities in the personalized preprogrammed process; or managing and analyzing a voting process activated as a personalized preprogrammed process, wherein the authorized voters are the personalized preprogrammed process' communicating entities transferring their votes to the process initiator by submitting their related activation messages according to the process communication rules and access rules.

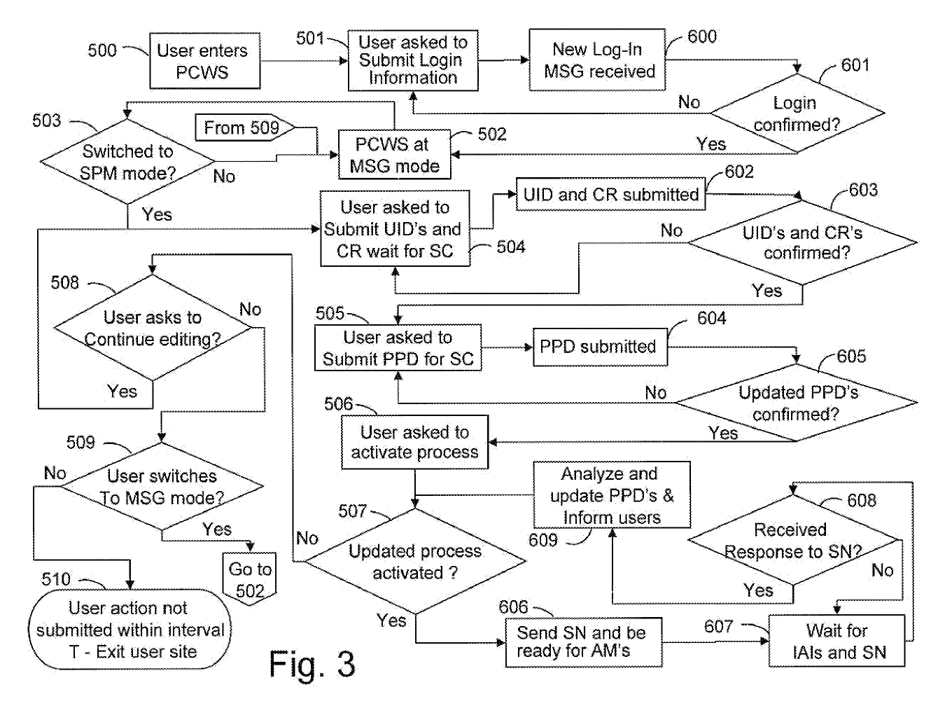

### FIG. 3, Subscription and Preprogramming Personalization of PCWS User Site (User and Server—View)

The current invention has one embodiment, which teaches the preprogramming of communication and processes on the PCWS system. This embodiment is described by the high-level flow chart diagram of FIG. 3.

For consistency, the arrows exiting on the left or right of the diamond shape conditional process in the flow description of the charts refer to No—negative decision, where a YES—positive response flows is plotted by downwards or upwards arrows. The process flow described below with square parenthesis [. . . ] as a reference to the process stages plotted in FIG. 3.

FIG. 3 describes the process where a PCWS user (USER) enters the PCWS site, for starting the process of preprogramming at step [500].

In order to START Subscription and Personalization of the PCWS site, all users are required to—[500 Enter PCWS web site] and identify themselves by submitting log in information—[501 User asked to submit Login In information]. In order to speed up validation of new user data, new user may be required to categorize his characteristics so that optimal site will be allocated for further personalization of PCWS processes.

Once the server received a new Log-In message—[600 New Log-In MSG received], it examines the USER details for confirming log-in (User name and pass-word) and if new, it allocates new personalized site for the new-user —[601 Login confirmed?].

If user details mismatch database for any reason it switches the user back to identification step—[IF 601 No—return to 501]. If USER data is validated and personalized site exists—[IF 601 YES—Go to 502]. PCWS opens the personalized site in MSG-Mode [502 PCWS at MSG mode], which enables USER web-based communication with other USERS by triggering communication directly from the personalized site.

For editing the communication processes the USER should switch MSG-site mode to Site-Personalization-Mode (SPM)—if [503 Switched to SPM mode? the first and mandatory task of editing the personalized site is defining/editing/confirming, guided by PCWS, of USER Identified Communication Devices (UIDs are utilized to initiate processes and are related to the sets of communication rules that are activated when the USER is called by other USER's processes or by the PCWS.

[504 User asked to submit UIDs and (CR) wait for SC]. (SC—Server Confirmation).

Upon completion of UIDs and default-CR definition, [602 UIDs and CR submitted], PCWS checks validity of data and rules, if changed,—[603 UIDs and CRs confirmed?]. If invalid—USER is switched back to former step 504—with invalidity reasoning on screen—[If No—return to 504].

If all data is found valid, USER is switched to process editing mode—[IF 603 YES—Go to 505], [505 User asked to Submit PPD for SC] where each edited or added process must include all relevant Personalized Process Details (PPD):
1) A list of Identified Authorized process Initiators (IAIs) and their optional identified devices (IAIDs).
2) A Process Identifier (PI) proposed or enforced by the PCWS.
3) A detailed definition of other Communicating entities' Identified Devices (CEIDs), for each communicating entity included in the process.
4) Associated communication rules (search algorithms) applied to the CEID's when the process is triggered by a USER or other IAI.
5) Process Content and Timing (PCT) defining the nature of information transmitted and the timing for triggering the process with the timing of the process Activation Message (AM).

Each newly saved edited process is transferred for validation and confirmation by the PCWS—[604 edited PPD submitted for confirmation], [605 Updated PPD's confirmed??], If invalid—USER is switched back to the process-editing mode with invalidity reasoning—[If No—Return to 505].

If valid, PCWS authorizes switching of process status from pending to operational and USER can activate it by assigning activation rules to the edited process including the limits of authorizations to IAIs who are not the process creating user—[IF 605 YES—Go to 506], [506 User asked to Activate process].

If edited process is activated by its editor—[507 Updated process activated?] PCWS is ready for activation message of the process and in parallel sends Server Notifications (SN) to all relevant new authorized process initiators and communicating entities included in the process, notifying them about the nature of the process and the IAIDs and CEIDs with which they will be connected to it for or upon activation, respectively, enabling them to respond to such notification with rejection or certain limited process modifications—[606 Send SN and be ready for AM's].

Upon delivery of the notification, PCWS waits for IAIs and communicating entity response to the message (which is mandatory only if so defined by the process creator/editor!)—[607 Wait for IAIs and CE response to SN]. When response is received [608 Received response to SN?], and it changes data in the current definition of an active process, PCWS analyzes IAIs and communicating entities' response, updates PPD and notifies process creator for enabling renewal or modification of activation rules—[609 analyze and if needed update PPD's & Inform users], and go to former step [507].

If another process should be added or edited or another action should be take [508 User asks to Continue editing?] PCWS returns to [504] above. If no further editing is required system checks if USER wishes to return to PCWS MSG mode—[509 User switches To MSG mode?]. If “yes”, PCWS returns to [502] above, and if “no” it waits for further USER instruction at the site for interval time T after which it exits the program [510 User action not submitted within interval T—Exit user site].

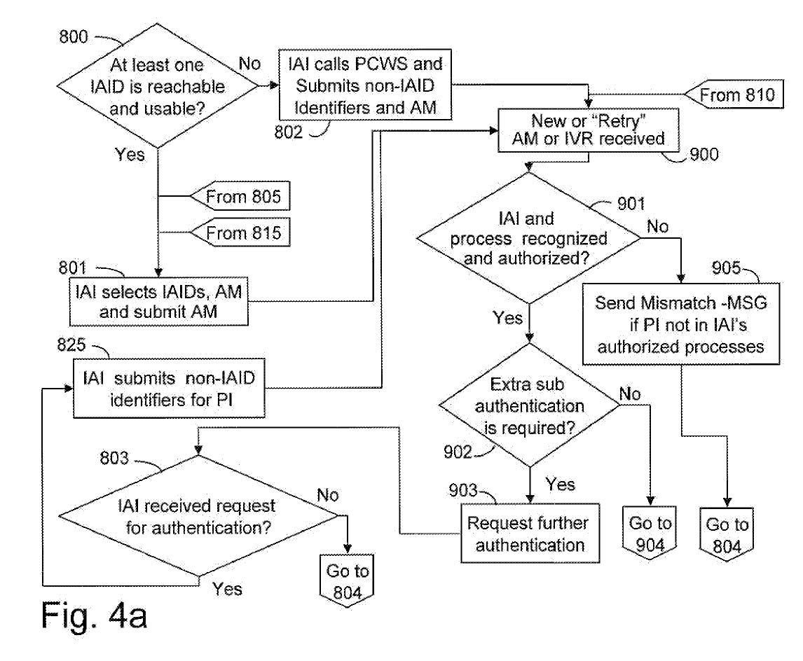

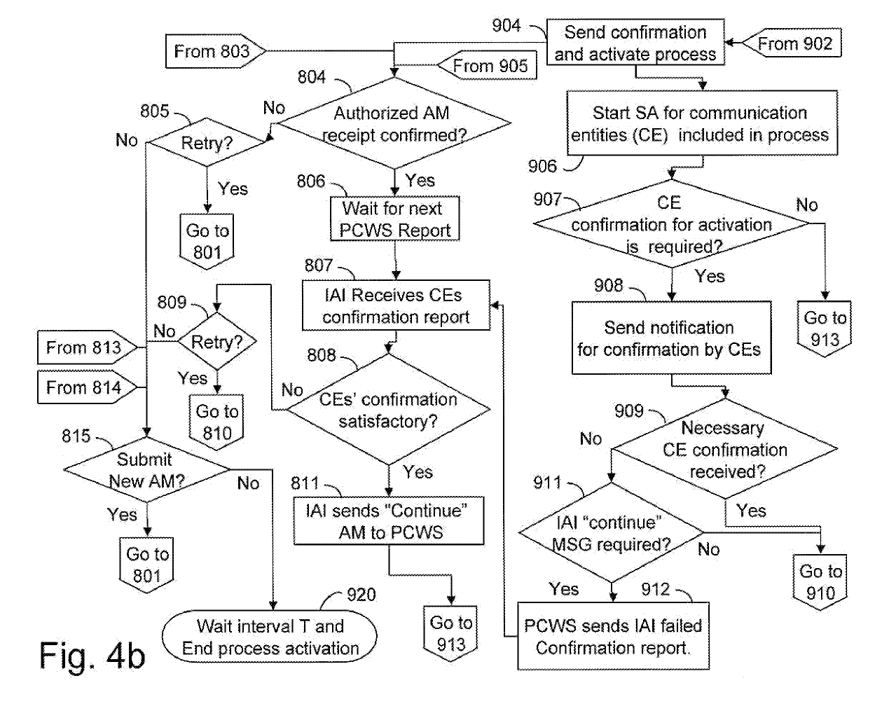

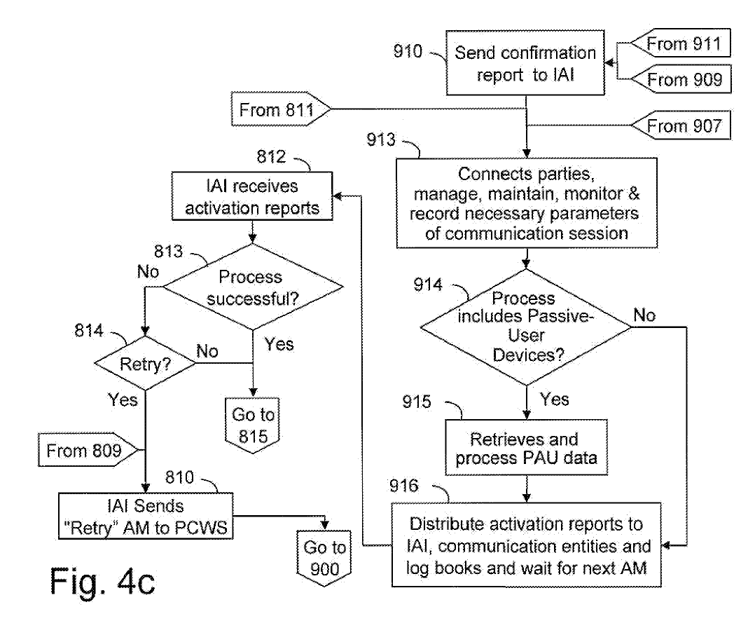

### FIGS. 4a, 4b, and 4c, Activation of Preprogrammed Connunication Processes on the PCWS Personalized Site (User and Server—View)

The current invention has another embodiment, which teaches the activation of preprogrammed communication processes on the PCWS system when a user (USER) submits a short Activation Message (AM) either by direct connection and password verification, or by utilizing a User Identified Device (UID) recognized by the personalized site.

The pre-requisites for activating such a communication process are:
1) User (USER) owns a site, which is already preprogrammed and containing such data as the UIDs used by the USER and if necessary relevant passwords.
2) Relevant communication rules (CR) for approaching the UIDs given different “filtering” modes.
3) Relevant communication processes which are personalized by the User, are switched from “pending” status to “operational” by the USER.

The Identified Authorized process Initiator (IAI) steps of process activation are described by the high level flow charts diagrams of FIGS. 4 (a,b,c).

For consistency, the arrows exiting on the left or right of the diamond shape conditional process in the flow description of the charts refer to No—negative decision, where a YES—positive response flows is plotted by downwards or upwards arrows. The process flow described below with square parenthesis [. . . ] as a reference to the process stages plotted in FIGS. 4 (a,b,c).

In FIG. 4a, an IAI logs into a relevant PCWS site, preferably using one of his IAIDs or using passwords based connection if no IAID is available in order to activate preprogrammed process using an Activation Message (AM). The steps start at [800]. The first step for starting the process activation is verifying the existence of at least one single reachable and usable IAID—[800 At least one IAID is reachable and usable?], and when such UID exist [800=YES] it continues directly to selection of a relevant UIDs and submission of the selected AM corresponding to the process which is planned to be activated—[801 IAI selects IAIDs, AM and submit AM].

The IAI should select the process for activation using one of five major alternatives: 1) Selection from a process list stored in the IAID memory; 2) Keying the process identifier (number) using the IAID keypad; 3) Calling the PCWS Interactive Voice Response (IVR) channel and selecting the process (using DTMF or voice-wise) out of a list stored in and presented by the PCWS, after a proper identification as an Authorized initiator; 4) Surfing into the relevant personalized web site using suitable IAID (including but not limited to a “Smart-Phone” (Mobile communication device with surfing capabilities), PDA, PC, Laptop) and selecting the process from the approved and activated process-table; 5) Creating an IM, SMS, MMS, a graphic description or picture or a video clip, uniquely defining the IAID and the process identifier.

The navigation through Interactive Voice Response (IVR) is very common on many PBX and soft switches, thus users are familiar with the process of selecting options using communication devices, by response to voice and DTMF (Dual Tone Multi-Frequency) activated menus. Such selection mode is especially useful when the UID is a standard simple Phone handset without display and has limited build in memory to store the AMs.

Once a process is selected, sending of activation message (AM) is conducted per existing standard procedures and keys used for placing a call or sending a message such as, but not limited to “Send”, “Enter”, “OK” commands of the relevant IAID, or voice activation command when applicable.

If however the answer to [800] above is negative, the PCWS maintains an alternative mode of receiving AMs when no IAID is usable for the USER. If such a case happens, IAIs can either call the PCWS IVR line through a communication channel other than the IAID and use the IVR system to identify themselves using agreed identifiers that are listed in their personalized site, or send a message to the PCWS message line containing all the necessary identifiers as instructed by the web site. [802 IAI calls PCWS and submits non-IAID Identifiers and AM]. Once all such identifiers are accepted by the PCWS the AM is treated as nay standard activation message.

The PCWS starts its role in activating a communication process upon receiving a new “AM” or a call at the dedicated IVR line—[900 New, “Retry” or “Continue” AM or IVR received].

Upon receiving “AM” or voice call, PCWS identifies the process initiator utilizing the IAID identifier, or relevant pass-words if they exist (particularly if mandatory per process specs), and starts validating the selected process utilizing the received Process Identifier (PI) embedded in the AM or the process selected by the IAI utilizing the IVR process—[901 IAI and process recognized and authorized?], and checks if all identification and authentication requirements fulfilled.

If authentication of activated process fails, PCWS sends a “mismatch message” to “AM” sender—[If 901=No go to 905], [905 Send Mismatch-MSG if PI not in IAI's authorized processes], [Go to 804], (905 also refers to any mismatch message to a non-identified sender if included in the PCWS response protocol).

If IAI and PI are identified and authenticated, and NO extra authentication is required [902 Extra sub authentication is required?] the process is ready for activation—[If 902=No go to 904], PCWS sends a confirmation of receipt to “AM” sender, and starts process activation including activating the “Search-Find & Connect” algorithm as defined for each of the activated process' communicating entities—[904 send confirmation and activate process], [906 start SA for communication entities included in process].

If however, certain authentication of the user is missing, [901=Yes], PCWS informs the IAI about the missing data [903 Request further authentication]. When such a message is received by the IAI [803 IAI received request for authentication?], the user transfers to the PCWS all mandatory non-IAID identifiers as required by process specs [825 IAI submits non-IAID identifiers for PI], the process flows back to [900] above and when authentication is positively finalized it flows to [904]→[906] as described above. If 803=No the process continues to [804 Authorized AM receipt confirmed?]

Once a PCWS report with regard to activation process [804] is received, IAI can evaluate AM status. If AM receipt is confirmed, IAI waits for next PCWS report regarding activation process—[If 804=Yes, go to 806], [806 wait for next PCWS Report]. If AM receipt is not confirmed, IAI needs to decide if activation should be retried—[If 804=No go to 805], [805 Retry?]. If “retry” is selected, flow goes back to [801] [If 805=Yes go back to 801]. If IAI decides not to “retry” activation, [805=NO] and not to select a new AM [815 Reselect and submit new AM?], PCWS ends process by the end of pre-set “wait-state” [If 815=No, Go To 901], [920 Wait interval T and End process activation].

If communicating entities' confirmation for activating the process is required [907 communicating entity Confirmation for activation is required?], and 907=Yes, [If No go to 912], PCWS sends all relevant communicating entities notification for confirmation and waits for response [908 send notification for confirmation by communication entities]. If necessary (sufficient) response is received by PCWS [909 Necessary communication entities confirmation received?] and 909=YES, PCWS sends communicating entities' confirmation report to IAI [910 Sends confirmation report to IAI] and starts connecting all relevant communicating entities [913 Connects parties, manage, maintain, monitor & record necessary parameters of communication session]

If communicating entities' confirmation is insufficient [909=NO] and IAI further instruction to PCWS is required—[911 IAI “continue” MSG required?], 911=YES, PCWS sends failure report to IAI—[912 PCWS sends IAI failed confirmation report.] and waits for further instructions. If however, communication entities' confirmation for activation is not mandatory for process activation, [907=NO], the PCWS continues with activation directly to [913] above.

When IAI receives communicating entities' confirmation report [807 IAI receives communication entities' confirmation report], the report is examined and if sufficient for continuing activation [808 communication entities' confirmation satisfactory?], 808=YES, IAI can send a “continue” message [811 IAI sends “Continue” AM to PCWS] which sends the PCWS directly to [913] which continues the process with connectable entities. If however 808=NO, IAI can request a “retry” from the PCWS [809 retry?]. If 809=YES the process flow to IAI sends a “retry” message [810 IAI Sends “Retry” AM to PCWS] and the process flows to [900] above. When 809=NO, the process flows to [815] above.

Continue to PCWS flow chart 913; Once PCWS receive all necessary clearance to smartly connect all the relevant process' communicating entities, it reaches the communicating entities through the optimal and available (responding) CEIDs as defined in the process communication rules and continues managing the process till completion, making sure that all links are kept “ON” for the required session, or reconnected if disrupted during session. Communication-management reports are defined and sent to process initiator or communicating entities or predefined log-books and databases (such as user's log-book on the PCWS and relevant billing reports) per process protocol

In the specific case of inclusion of Passive-User-Devices (PAU) in the process—[914 Process includes Passive-User Devices?], the PCWS retrieves all data sent by the PAU, analyzes it per process specification, sends the relevant Active users relevant parts of the PAU data or reports and stores, if applicable, certain parts of the data in databases as defined in the process [915 Retrieve and process PAU data], and in all relevant cases the PCWS distributes the reports to all relevant entities and log books and wait for next AM [916 Distribute activation reports to IAI, relevant communication entities and log books and wait for next AM]

Upon receiving PCWS activation reports [812 IAI receives activating reports], IAI can evaluate the process outcome. If considered successful [813 Process considered successful?], the process flows to [815] above. If process considered unsuccessful [815=NO], IAI can still consider a “retry” [814 Retry?]. If [814=YES] the process flows to [810] above and if [814=NO] the process flows to [815] above.

The embodiments of the current invention described herein with reference to FIG. 1, FIG. 2 and the flow charts of, FIG. 3 and FIG. 4 enables the PCWS to be programmed to execute, upon receiving a short activation message, a variety of different processes incorporating part or all of communication related tasks such as predefined search, find, connect, maintain connection continuity and manage Information transfer per predefined algorithms.

One important example of a common application is an automatic creation of a predefined “group-call” or automatic set up of a “conference call” via the predefined process of bridging communication channels on the PCWS site utilizing the PCWS switching and routing capabilities.

In the “group call” example, a prioritized search processes for the group communicating entities' identified devices (CEIDs) can be initiated upon receiving an activation message (AM), and once a sufficient number of relevant CEIDs including CEIDs o communicating entities who are defined mandatory for establishing the call (per process specs) are searched for and found active, the devices can be switched together to form the required “Group-Call”. The activated process can include the IAID initiating the process as one of the Group-call CEIDs or another IAID of the same initiator, however such a demand is not mandatory and a USER can define a Group-call process that does not include his UIDs, or the IAIDs of alternative authorized initiators.

The above described PCWS “group-call” process is substantially different from today's conference call set-up processes, which are usually initiated by the participants who either dial a predefined conference-call-number managed by a “conference call switch”, or “summon” other participants to the call utilizing predefined network or PBX functionality of building conference calls.

The proposed process is superior to the currently used technologies since it automatically and centrally searches, finds and connects all relevant participants, utilizing economically and technically optimal and available communication networks and communication rules as prioritized by the process initiator, and then automatically maintains the connection, by optimally re-establishing disconnected links prior to session termination.

The automated central management can verify that group-call will not take place unless a predefined “quorum” and or mandatory participants were found and connected to the process. Furthermore, if certain required participants of the call are not found during the PCWS “search & find” activity that covers the variety of CEIDs registered as belonging to that participant, the automated process-manager can leave relevant personalized messages per relevant CEID enabling that person to signal the PCWS upon becoming available for immediate or delayed connection and indicating the preferred connection channel as part of that signal.

Managing a delayed group call is even more prominent feature of the PCWS capabilities when compared with the current technologies. In this case, upon receiving an AM for a delayed Group-call that includes a well defined call schedule, the PCWS can send notifications to all planned participants with the call parameters and also, if required, a request to confirm the schedule. The delayed automated activation and management of the call can rely on the actual response of the participants to such notifications and AM initiator reaction to the PCWS response-to-notification report.

The PCWS process may also incorporate a follow up information transfer for all participants via E mail, SMS or other forms, defining the meeting parameters (timing, cost etc.) and the group actual participants. It can also transfer information to a database for a follow-up use by billing and other call related services.

The PCWS software and activation messages may incorporate some extra features for optimal management of the Group call such as; a DTMF or voice activation via IVR of a Group-call recording on a remote server, centralized mute or disconnect command of certain participants' CEIDs during the call and creating sub-groups commands for separate discussions during the Group-call as well as reconnecting the subgroups at a later time.

All the described features may also be activated by a remote computerized devices operated by a process initiator logging into the PCWS personalized site. In such a case, the PCWS executes the process when receives activation via a simpler online control over process modifications procedures.

Another PCWS remote activation process of search find and connect for CEIDs, related but not limited to group-call activation, may incorporate a remote activation of a simultaneous connection to multiple CEIDs of say the same communicating entity. Such an activated process may include calling multiple mobile phone and landline simultaneously, as well as instantaneous sending of IMs (Instant Messages), SMS, or e-mails to the searched communicating entity notifying about the connection trial. Once the relevant communicating entity responds to one CEID, the process, if so defined, may terminates the call on the other CEIDs and if associated with a Group call, it will continue searching for other CEIDs or relevant IAIDs to be connected to the joint call.

The current invention applied to the centralized multiple call initiation, is particular useful in the case of potentially mobile communicating entities who prefer to use landlines when they are present at their home or office or prefer using an alternative communication channel that can be temporarily or permanently associated with them, but should not miss the search if they are away from such a channel. Such a case is particularly useful for communicating entities who ar also PCWS users that can flexibly manage the list of their CEIDs associated with any process they might be part of. For example, they can insert a temporary CEID identifiers, such as hotel line number of rented mobile phone number, for a limited well defined period, when they away from home and/or update the PCWS about new permanent CEIDs, and later be connected to the relevant processes in a transparent mode, (regardless of the fact that process initiator is not aware of the change in their CEID profile).

Another embodiment of the present invention further relates to processes that can be activated prior to the actual generation of a connection between a process initiator and other communicating entities for assisting tasks such as a proper initiation of a later connection. A typical example of such processes is “search and report” process, wherein the initiator of the process predefines a list of communication devices, and in particular CEIDs, which should be monitored by the PCWS for detecting and reporting their status or their readiness for certain communication process, or detectable changes in their status. The “search and report” preprogrammed process defines the CEIDs' list that should be monitored, the monitoring period, the types of reports presenting the monitoring results and related information, the events generating each report and the communicating entities of such reports depending on the reported data and schedule, including, when required the owners of such CEIDs. When the “search and report” results find suitable conditions for the initiation of another process which may be dependent on such conditions the PCWS can be programmed to automatically activate the “dependent process” after sending proper notification to all relevant communicating entities.

Another embodiment of the present invention relates to Passive Users (PAUs) registered at the PCWS by, and in relations to Active users, (ACSs) enabling such ACSs to personalize communication processes that are aimed at either activation of or monitoring and controlling of or retrieving information from such PAUs. In most cases the PAUs are instruments that include communicating devices for enabling them to be contacted by PCWS for activating preprogrammed processes that are embedded at their instrument control unit. ACSs owning PAUs that are registered at the PCWS are responsible for creating all relevant communication processes related to their properties including but not limited to defining all other IAIs that are allowed to activate specific PAU related process, or to change specific PAU status.

Typical PAU related processes are based on changing the PAU status (for example a command for activating or deactivating certain feature embedded in the PAU) and then receiving PAU reports or streamed information that are linked to either events or schedule or queries sent to the PAUs by an IAI. Certain PAU related processes could be designed to simultaneously communicate and activate more than a single PAU. In such a case the ACS sending the relevant AM should be authorized to activate all relevant PAUs, or else, if allowed within process specifications, the AM can enable partial activation related only to PAUs within the AM initiating ACS authorization.

Typical examples for PAUs are “smart home & office” or specific modules within such sites and remotely controlled mobile properties such vehicles, digital cameras and audio or video recorders or players of different kinds. In the first case of “smart home or office” the PAU related process could be conditional activation of certain instrument, for example air-conditioning units. The activated instrument can be either an independent PAU when includes an independent UID, or connected through local control link to the central controller of the “smart building” that can support different AMs relating to different instrumentations within its volume. Conditional activation can be changing status upon occurring of certain events or at certain timing. When the PAU is an information generator through either internal sensors or connection to information sources, the PAU related process can be “upon-event” or per schedule, via PCWS transmittal of required information to certain communicating entities defined by the process.

Another embodiment of the current invention relates to the service fees associated with building and operating personalized switching and routing communication web server (PCWS) in general, and in particular the services related to PCWS personalized sites and PCWS enabled service provisioning. Such fees may be associated with four major groups of activities; a) subscribing to the PCWS services including the personalization process of a PCWS site, b) management of a share-ware process library, c) actual activation of PCWS communication processes and d) utilizing the statistical facts related to the usage of specific communication processes and enabled services. Each of the above sources of service fees is expected to be managed utilizing a fee formula associated with the personalized processes where the fees are assigned on a case by case basis to certain entities as approved by the PCWS.

The fee formula in a) is related to the subscription to the PCWS and the related personalization of selected communication processes and can be based on parameters characterizing the user, such as but not limited to user-type, user links to certain group or organizational subscription or service provider of other PCWS services promoters, parameters characterizing the personalized processes such as but not limited to the number of authorized initiators, the types of operational personalized processes and their accumulated period of being operational, the total number of personalized operational processes, the assistance of PCWS staff in the actual personalization of the processes, and other commercial parameters such as the but not limited to user willingness to be exposed to advertisement while being logged-in to the site.

The fee formula in b) is related to the management of a share-ware process library and can be based on services supplied by the PCWS to new-process designers, service providers offering their services through the share-ware process library and users trying to enrich their preprogrammed portfolio. The parameters included in the fee formula are related to the type and complexity of the process designed or adopted, the categorized section to which such a process belong, the total number of processes adopted by a relevant user, the agreed relations between the process designer and the PCWS operator and the centralized assistance in the design or adoption and personalization of a library process.

The fee formula in c) is related to the actual process activation and can be based on a combination of user activity level (number of activated processes per given period), process sponsorship by service providers, the personalized process characteristics, such as but not limited to the type and parameters of the process activated, such as the type and number of activation messages sent, communication devices in use, type of information transferred between the parties, duration of the process, communication fee savings created by the process activation, and the users and communicating entities willingness to be exposed during process activation to advertisement and sponsorships.

The fee formula in d) is related to accumulating data regarding PCWS process initiators and related communicating entities and process activation statistics based on either identified users or non-identified user analysis which may be required for market analysis for service providers of different types, and particularly but not limited to such service providers utilizing the PCWS voting services.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method comprising:
providing a plurality of preprogrammed processes and preprogrammed software tools stored in libraries and sites accessible to an authorized user, wherein the plurality of preprogrammed processes and software tools are available to said authorized user for supporting creation and qualification of an identified personalized preprogrammed process governed by personalized communication rules, access rules and activation restrictions;
storing a personalized preprogrammed process and related parameters at personalized sites accessible to authorized personalized communication web-based server;
receiving an activation message submitted by a process initiator through at least one accessible communication network, said activation message including identifiers of both the authorized initiator and a personalized preprogrammed process to be activated;
identifying and validating the activation message and then authorizing or rejecting the activation of the personalized preprogrammed process; and
managing and maintaining an activated personalized preprogrammed process per its embedded personalized communication rules, access rules and activation restrictions utilizing the personalized communication web-based server and accessible communication networks.

2. The method of claim 1 further comprising at least one of the following:
identifying the authorized user of the personalized communication web-based server using identifiers defined upon authorization of said authorized user, said identifying including an agreed combination of at least one of communicating device identifiers, user's name or password;
utilizing a preprogrammed process library of preprogrammed processes offered to authorized users, wherein personalization of said preprogrammed processes from the preprogrammed process library includes defining the communicating entities participating in the personalized preprogrammed processes, the communication rules to be employed by the server when activated by said authorized user, and any modifications of the preprogrammed processes related to information transferred between the communicating entities;
utilizing preprogrammed qualification rules offered to authorized users, thereby allowing said authorized users to preprogram processes based on said rules and server qualification, prior to adding the preprogrammed processes to their personal site or to another process library;
identifying the personalized preprogrammed processes using either identifiers selected upon personalizing the preprogrammed processes by said authorized user, said identifiers including identifiers connected to the preprogrammed processes appearing in the preprogrammed process library prior to customization or identifiers selected and approved by the personalized communication web-based server as part of the process personalization;
identifying the communicating entities involved in each personalized preprogrammed process through the identifiers of communicating devices associated with communicating entities and preferred communication rules to be employed upon activation of the personalized preprogrammed process;
enabling prioritized searching for and finding of participating communicating entities' communicating devices, based on communication rules defined by communicating entities involved in the activated process and availability of both communication channels and searched-for communicating devices;
enabling information transfer between communicating entities, automatically modified as required by the personalized communication web-based server to formats and limitations of the communication channels and communicating devices employed in the activated process; or
maintaining communication continuity while the personalized preprogrammed process is active, including replacing communication channels or communicating devices if said channels or devices become unavailable during the activated process or adding channels or devices per authorized activation message received by the server.

3. The method of claim 1 wherein at least one of the preprogrammed processes relates to:
information transfer of at least one of voice, video, data information or data command;
information transfer related to the availability, status, and results of the activated process, the information transferred to the process initiator and to any communicating entity associated with the activated process which is predefined as a recipient of such information;
information transfer including format modification to fit the established connection channels or format modification resulting from a change of connection channels;
information transfer from at least one passive user to communicating entities' devices per process specification upon occurrence of an event triggering the information transfer as predefined by the activated process, wherein the information is transferred to relevant communicating entities identified devices, specific personalized communication web-based server personalized sites, and other sites of the communicating entities;
online monitoring and control methods given to the active users and other authorized process initiators enabling such active users and other authorized process initiators to activate and control certain passive users, to activate and control the information transfer from said passive users, and to redirect the information by sending an identified control command through the personalized communication web-based server;
setting up of a mode of operation of a passive user by its owner or other authorized activator, wherein such set up defines the event-related activation messages sent by such passive user, the set up accomplished by a predefined activation message sent by an authorized process initiator of said passive user through the personalized communication web-based server;
controlling an event, internal to the passive user, which initiates information transfer to a memory, external to the passive user, when networking becomes available; or
controlling an event, external to the passive user, which initiates the information transfer, the controlling including detection of said event by the passive user's sensors, wherein records of such event are preprogrammed to be transferred to certain communicating entities identified devices upon predefined detection circumstances.

4. The method of claim 1 further comprising:
defining mandatory rules for activating a group call including a preprogrammed schedule, a “quorum” of participating for activation, preprogrammed call managers having rights to connect and disconnect participants and to record and to terminate the call, and sending preprogrammed notifications before, during and after the call;
connecting communicating devices related to communicating entities in a group call configuration formed and managed by the personalized communication web-based server upon receiving a relevant activation message;
enabling authorized users to transmit activation messages related to their participation in the activated process, including activation messages related to delayed connection, change of user identified device for the process, change of preferred language or forwarding the connection to another user identified device; and
monitoring and controlling methods given to an initiator and authorized managers of the call, the monitoring and controlling enabling the initiator and authorized managers to send activation messages or control commands to the personalized communication web-based server during the group call, the activation message or control commands originating from preprogrammed user identified devices.

5. The method of claim 1 further comprising:
analyzing alternative communicating entities identified devices participating in the activated process and the available channels when said process is activated, and selecting the channels based on predefined technical and economical considerations together with any authorized user preference of selected devices, channels and allocated communication resources;
enabling simultaneous activation of multiple alternative communication channels related to a single communicating entity;
monitoring a communicating entity response to the activated channel;
disconnecting redundant connections based on preprogrammed prioritization; and
transferring a channel-customized preprogrammed message to relevant communicating entities identified devices if no required response of the relevant communicating entity is received.

6. The method of claim 1 further comprising at least one of the following:
storing any necessary activation and process parameters for further reporting to, and billing for usage by, relevant entities connected to the preprogrammed process activation;
activating passive user identified devices, wherein said devices can perform at least one of the following: acknowledging the activation, reporting the execution status of the requested activity, or reporting activity results;
responding to a proposed interaction including an advertised interaction, that includes an authorized communication process, wherein the process identifier corresponding to the authorized communication process is either automatically defined and assigned by the said communication server or defined by an authorized service provider proposing the said interaction;
responding to a service request wherein a preprogrammed process associated with the service request and process identifier associated with the service request are personalized by an authorized user, the service request defining service description and selecting a specific service provider through its associated communicating entities identified devices;
responding to a service request wherein a default preprogrammed process associated with the service request and process identifier associated with the service request are defined and inserted automatically as a pending process to an authorized personalized site by the personalized communication web-based server and is switched by the authorized user to an operational process upon personalizing service parameters, the responding including any necessary qualifying of the pending process; or
interactively managing default services offered by authorized service providers or by the personalized communication web-based server, wherein authorized users can either accept and personalize the preprogrammed process and automatically presented default services or reject them by requesting partial or complete blocking of attempts to activate said default services, wherein partial blocking requires user definition of activation circumstances.

7. The method of claim 1 further comprising at least one of the following:
providing modification and qualification tools and online personalized communication web-based server support for personalized preprogrammed process creation or editing;
providing qualification testing prior to activating a modified process;
providing software processes enabling authorized process creators to offer their qualified preprogrammed products to authorized users under a predefined usage agreement;
managing authorizations and online support for users who wish to execute at least one of the following tasks:
using a personalized communication web-based server preprogrammed process library;
modifying processes adopted from the personalized communication web-based server preprogrammed process library;
using process creation, modification, and personalization tools;
using process qualification testing;
licensing preprogrammed qualified processes, created by the licensor through the personalized communication web-based server platform, to authorized users as either communication tools or other service provisioning tools; or
partially or absolutely blocking a usage associated with certain types of processes or certain types of service offers;
monitoring, controlling and allocating process identifiers of at least one of the following process categories:
preprogrammed processes offered by the personalized communication web-based server preprogrammed process library to authorized users;
preprogrammed processes modified by authorized users for private usage by a predefined user base; or
preprogrammed processes that are adopted from the personalized communication web-based server preprogrammed process library and then modified and qualified;
newly created processes in a qualification phase;
automatic and semi-automatic insertion of certain user parameters into process configuration during personalization; or
highlighting personalized, modified, and modification-restricted parameters within the preprogrammed processes.

8. The method of claim 1 further comprising:
monitoring the activated process and online transfer for storage in databases of information for reporting parameters and usage data related to the activated process or other personalized communication web-based server services;
translating data related to usage of personalized communication web-based server services to generate data and related fees that are assigned or linked to at least one of the following:
an associated service provider or process creator wherein fees are related to a default communication process stored in a share-ware preprogrammed process library, per predefined fee formula;
a service provider associated with an individual process adopted by a personalized communication web-based server user;
a process customization conducted with the aid of the personalized communication web-based server service, infrastructure or call-center to be paid to or by a process creator who stored a qualified process in an library according to an agreed fee formula;
submission of activation messages according to a fee formula associated with an accumulated list of activated processes in a given period and associated with recorded process parameters;
entities defined by the personalized preprogrammed process including the owner of the personalized site, a process initiator, a service provider connected to a service provisioning process, an advertiser promoting a service or a product, utilizing the personalized preprogrammed process, a voting process or polling process organizer utilizing the process, and the personalized communication web-based server operator;
an organization requiring statistical data derived from the activation message-related data or personalized communication web-based server service usage habits monitored by the personalized communication web-based server;
entities interested in statistical information related to behavior of certain process activations by an entire or a well-defined part of the personalized communication web-based server users base as monitored by the personalized communication web-based server;
initiator's and communicating entities' communication channels operational cost savings achieved by a personalized communication web-based server optimized communication process;
a number of activation messages sent by the IAIs to the personalized communication web-based server in relation to a certain process;
a successful connection between the initiator and relevant service provider or service provider related service;
a transaction initiated as a result of the connection;
a service provider related to a default communication process stored in a share-ware preprogrammed process library, wherein the fee formula is linked to the number of activation messages used for activating a process or its personalized derivatives by personalized communication web-based server process initiators;
owning a site which generates service fees according to a fee formula, the service fees assigned to an entity committed to pay site ownership fees;
each individual process stored at the personalized site for a given period of storage time; or
an authorized user or service provider that created a personalized communication process from a process copied from a share-ware preprogrammed process library, wherein the fee formula is associated with specific process adopted by the authorized user and a total number of adopted processes.

9. The method of claim 1 further comprising at least one of the following:
defining an authorized user's optional identifiers, including the identifiers of authorized user's identified devices through which activation messages are expected to be submitted, the identified devices through which the authorized user is connected as a communication entity, and other identifiers activation message including any necessary access codes;
qualifying user's optional identifiers, including the identifiers of authorized user's identified devices through which activation messages are expected to be submitted, the identified devices through which the authorized user is connected as a communication entity, and other identifiers including any necessary access codes;
defining modular sets of communication rules per authorized user or other communicating entities to be included in a personalized preprogrammed process created by the authorized user, wherein the communication rules are to be utilized by the personalized communication web-based server when connecting to communicating entities per personalized preprogrammed process or upon receiving a valid activation message during an active process, the activation message for activating or deactivating certain communication rules modules;
qualifying modular sets of communication rules per authorized user or other communicating entities to be included in a personalized preprogrammed process created by the authorized user, wherein the communication rules are to be utilized by the personalized communication web-based server when connecting to communicating entities per personalized preprogrammed process or upon receiving a valid activation message during an active process, the activation message for activating or deactivating certain communication rules modules;
personalization of preprogrammed processes by an authorized user, or on behalf of the authorized user, the personalization based on at least one of the following options:
the personalized preprogrammed process is built utilizing personalized communication web-based server software tools, usage guidelines and qualification procedures;
the personalized preprogrammed process or certain modules of the personalized preprogrammed process are adopted from a preprogrammed process library and modified to fit the authorized user's and relevant communicating entities' requirements, including identifiers and titles of personalized preprogrammed processes, participating entities, devices, communication rules, authorized initiators and managers of the personalized preprogrammed process, preset messages or other information to be transferred between the communicating parties in association with the personalized preprogrammed process;
qualifying personalized preprogrammed processes created by an authorized user, or on behalf of the authorized user, the qualification related to at least one of the following options:
the personalized preprogrammed process is built utilizing personalized communication web-based server software tools, usage guidelines and qualification procedures; or
the personalized preprogrammed process or certain modules of the personalized preprogrammed process are adopted from a preprogrammed process library, and modified to fit the authorized user's and relevant communicating entities' requirements including identifiers and titles of processes, participating entities, devices, communication rules, authorized initiators and managers of the personalized preprogrammed process, preset messages or other information to be transferred between the communicating parties in association with the preprogrammed process;
exporting personalized process titles and process identifiers from an authorized user's personalized communication web-based server site to at least one of the authorized user identified devices, enabling prompt transmittal of activation messages using the activation messages identifiers which are stored and accessible in the identified device memory files including the contact book file;
organizing the personalized process identifiers to be included in a personalized process list for enabling translation of process title and identifiers to contact items in a contact book, wherein the process title is translated to the contact name and the process identifier is translated to communication channel identifiers operated by the personalized communication web-based server, such that exporting the process-related contact book from the personalized communication web-based server personalized site to an authorized user device, either manually or through a synchronization software, exports the activation messages for activating personalized processes, as listed as part of the personalized process list in the said personalized site to a contacts list within the device, for enabling single click type transmittal of the activation messages to the personalized communication web-based server, in which the user identifier is the calling device ID and the process identifier is the personalized communication web-based server-called communication channel;
enabling the personalized communication web-based server authorized user or other authorized process initiator to connect part of the personalized preprogrammed processes that are stored in relevant identified authorized initiator's communication device initiator's communication device contact book to quick dial keys, wherein the quick dial keys are included either within the initiator's communication device keypad or within permanent soft keys appearing on the initiator's communication device display, based on the initiator's communication device features, for enabling a true one-touch submission of activation messages;
enabling the personalized communication web-based server authorized user to communicate with at least one of the communicating entities included in a newly-formed personalized preprogrammed process for sending notifications to such communicating entities, the notifications specifying at least one of the following data items related to the newly-formed personalized preprogrammed process:
the newly-formed personalized preprogrammed process title and its creator;
the newly-formed personalized preprogrammed process objectives;
the communicating entities involved in the newly-formed personalized preprogrammed process and their roles; or
the information describing the search algorithms related to the communicating entities' communicating entities identified devices, the information enabling the notified entity to confirm, reject or reprogram specific modifications of the relevant process parameters, relating to the notified communicating party's inclusion and role in the newly-formed personalized preprogrammed process and to update the process creator through the personalized communication web-based server, specifying requested changes of the newly-formed personalized preprogrammed process.

10. The method of claim 1 further comprising at least one of the following:
a) validating an activation message at the personalized communication web-based server, and authorizing or rejecting the process activation wherein the activation message is sent by a process initiator, the validation and authorization comprising:
receiving the transmitted activation message at at least one of the personalized communication web-based servers;
decoding the activation message, including the identifiers of the authorized initiator and the selected process, and when the message is sent by an identified authorized device via personalized communication web-based server operated communication channel, and a called channel identifier is associated with the process identifier as defined at the authorized user's personalized communication web-based server site, extracting the associated process identifier; and
verifying the validity of the selected process by verifying inclusion of the identified authorized initiator and the identified process in an authorized user's site and the authorization granted to the initiator to activate the process;
authorizing or rejecting the selected process's activation when the activation message is validated or invalidated under the circumstances of receiving said activation message, respectively,
b) upon process validation and process authorization, managing the communication with the process initiator per process communication rules including:
terminating the communication link upon receiving control channel data through the called channel prior to establishing a voice or data communication session, and then establishing communication with relevant communicating entities per process communication rules; or
continuing the communication session with a process initiator upon receiving control channel data through the called channel using the called channel employed for receiving the activation message and managing the communication session with other communicating entities per process communication rules;
c) upon setting the preprogrammed communication channels between the communicating entities, managing the activated process, including:
controlling continuity of the activated process; and
reactivating relevant communication channels upon disruptions;
issuing acknowledgements to the process initiator and to other communicating entities, as defined by the process communication rules;
d) receiving additional activation messages or control commands by the personalized communication web-based server from an authorized user during the activated process and executing the additional activation messages or control commands while managing certain in-progress processes, the in-progress processes previously activated by authorized users; or
e) monitoring the activated process and storing defined process parameters for prompt re-establishment of a disrupted activated process and for enabling reporting of activated process details and results during at least one of the activated process or upon termination of communication sessions.

11. The method of claim 1 further comprising management of voting processes, enabling an authorized voting process creator to customize the process for a specific usage, wherein said voting processes are activated by a short activation message which includes authorized user identifier and activated process identifier, the method comprising:
providing a personalized preprogrammed process to perform, upon remote activation, preprogrammed voting processes, wherein voting processes comprise additional processes requiring remote prioritized selections of preferences within a given list of alternatives, a given voter-base of relevant authorized users, and a given period of time for receiving voting messages;
receiving a voting message in response to an activation of the voting process wherein the process identifier included in the message represents the selected alternative as at least one of the following:
authorized user pre-selected, general purpose voting messages, included in a personalized library at the personalized communication web-based server site as up to “m” preprogrammed processes of selecting item “n” out of “m”;
personalized communication web-based server pre-selected, general purpose voting options inserted into a share-ware preprogrammed process library as “m” preprogrammed options of selecting item “n” out of “m”; or
personalized communication web-based server allocation of voting options' identifiers associated with the activation of a specific voting process including the process identifier being alpha-numerically correlated with a marking on the selected option, wherein the personalized communication web-based server allocated identifiers cover a full range of the voting options, enabling sending the selected option number by a single short activation message;
an online presentation to potential voters of the selected voting options and their correlation with the activation message as part of the process activation;
combining personalized communication web-based server resources and voting organizer needs enabling alpha-numeric correlation between marking on the selected option, and the personalized communication web-based server allocated identifiers, covering the full range of the voting options, and enabling sending the selected option number by an intuitive short activation;
analyzing the accumulated voting messages, enabling online elimination of multiple votes submitted by a same authorized user for automatic disqualifying of authorized users, exceeding the maximum allowed number of voting messages per user;
responding immediately to voters with subsequent questions relating to the voting process or to their specific vote by relying on an online analysis of the voting messages;
presenting and displaying online the accumulated voting results, wherein said results may depend on typical voters' parameters including geography, voting time, and other parameters that can be used to classify the voter, or analyze the voting statistics, including broadcasting or submitting the results through other media channels capable of presenting the analyzed results numerically or graphically;
distributing the voting results to the relevant voters upon completion of specific stages of the voting process;
utilizing the stored parameters in the personalized communication web-based server to generate data and related fees that are assigned to a service provider utilizing the personalized communication web-based server general purpose voting method and process, wherein activation messages fees are calculated based on a predefined fee formula, linked to at least one of the following:
number of voting activation messages used;
a period of time allocated for the service provider for using such general purpose activation messages;
a peak capacity and total number of expected voters during the period of time;
an actual number of activation messages received and processed during an activation period of the voting process; or
a type of information feedback transferred during and after a voting session to the service provider organizing the voting session and the voters.

12. The method of claim 1 further comprising identifying and authorizing or rejecting the personalized preprogrammed process to be activated using an identified combination of the following:
authorized process initiator identifiers;
the activated process identifier; and
relevant circumstances of submitting the activation message when the activation is restricted to specific circumstances.

13. The method of claim 1 wherein the activated process identifier is created either by an authorized user during a personalization process or by the personalized communicated web-based server during the personalization process.

14. The method of claim 1 wherein the activated process identifier is extracted from channel identifiers of the communication channel called by an authorized user, wherein the process identifier is correlated to the channel identifiers or the process identifier is correlated to the combined channel identifier and process initiator identifier.

15. The method of claim 1 wherein the personalized preprogrammed process is saved in an authorized user's library, the authorized user's library associated with the user's personalized communication web-based server site accessible to the personalized web-based communication server for validating and authorizing the activated process and for receiving the personalized requirements and rules of the said personalized preprogrammed process.

16. A computer-readable medium storing instructions that, when executed by a computer, cause the computer to perform the method of claim 1.

17. The method of claim 1 further comprising at least one of the following:
adopting a preprogrammed process and personalizing at least one of the following:
authorized process initiators, their identifiers, and circumstances allowing said initiator to initiate said created process;
authorized process initiators' communicating devices, their identifiers, and communication rules related to said devices;
communicating entities included in the preprogrammed process and related communicating devices and communication rules applied to communication with said entities;
messages and other type of information transferred between communication entities during process activation per activation circumstances;
using the preprogrammed software tools for modifying logic of a preprogrammed process;
using the preprogrammed software tools to combine and modify more than one preprogrammed process into a single created personalized preprogrammed process; or
using the preprogrammed software tools to create a new personalized preprogrammed process which is not a modification of an existing preprogrammed process.

18. The method of claim 1 further comprising verifying that a newly created personalized preprogrammed process is qualified according to at least one of the following:
authorizations given to the authorized user;
authorizations given to authorized process initiators, including access rules and activation restrictions as personalized for relevant authorized initiators;
communication process and communication rules defined by a process creator when compared with limitations of networks to be used by the created personalized preprogrammed process and limitations imposed by network operators;
communication process and communication rules defined by the process creator when compared with the technical capabilities of communication devices to be used by the created personalized preprogrammed process;
the communication process and communication rules defined by the process creator when compared with communication rules defined by the communicating entities included in the personalized preprogrammed process as known during a creation phase of the personalized preprogrammed process or received in response to distributing personalized preprogrammed process details to said communicating entities;
a successful testing of the created personalized preprogrammed process;
qualifying procedures of the created personalized preprogrammed process by entities planned to manage and maintain it once activated;
qualifying procedures of the commercial terms; or
qualifying procedure of the rights related to the creator of the new process when compared with the rights of former process creators.

19. A system enabling prompt activation of personalized preprogrammed processes upon submitting an authorized activation message to a personalized communication web-based server, the system comprising:
means for providing a plurality of preprogrammed processes and preprogrammed software tools stored in libraries and sites accessible to an authorized user, wherein the plurality of preprogrammed processes and software tools are available to said authorized user for supporting creation and qualification of an identified personalized preprogrammed process governed by personalized communication rules, access rules and activation restrictions;
means for storing the personalized preprogrammed process and related parameters at personalized sites accessible to an authorized personalized communication web-based server;
means for receiving an activation message submitted by a process initiator through at least one accessible communication network, said message includes identifiers of both the authorized initiator and a personalized preprogrammed process to be activated;
means for identifying and validating the activation message and then authorizing or rejecting the activation of the personalized preprogrammed process; and
means for managing and maintaining the activated personalized preprogrammed process per its embedded personalized communication rules, access rules and activation restrictions by utilizing said personalized communication web-based server and accessible communication networks.

20. The system of claim 19 further comprising at least one of the following:
means for operating a plurality of personalized communication web-based servers utilizing a plurality of sites in a distributed network;
means for distributing the stored personalized preprogrammed process among a plurality of sites in a distributed network;
means for receiving the said activation message by a plurality of personalized communication web-based servers when said message is submitted serially or in parallel through a plurality of communication channels;
means for distributing the validation of the activation message and the authorization of the activated personalized preprogrammed process among a plurality of servers; or
means for managing and maintaining the activated personalized preprogrammed process by a plurality of personalized communication web-based servers.

21. The system of claim 19 further comprising at least one of the following:
means for enabling information transfer between communicating entities per personalized preprogrammed process requirements and communication rules;
means for controlling set-up of passive users participating in a personalized preprogrammed process prior to activating the personalized preprogrammed process;
means for establishing communication between active and passive users during an activated personalized preprogrammed process;
means for analyzing, authorizing and responding to activation messages submitted by authorized communicating entities during and in relation to an activated personalized preprogrammed process as part of the preprogrammed authorizations granted to said communicating entities in the personalized preprogrammed process; or
means for managing and analyzing a voting process activated as a personalized preprogrammed process, wherein the authorized voters are the personalized preprogrammed process' communicating entities transferring their votes to the process initiator by submitting their related activation messages according to the process communication rules and access rules.
